(19) United States
(12) Patent Application Publication
(10) Pub. No.: US 2022/0300679 A1
(43) Pub. Date: Sep. 22, 2022

(54) SIMULATING ELECTRICAL POWER GRID OPERATIONS

(71) Applicant: X Development LLC, Mountain View, CA (US)

(72) Inventors: LEO FRANCIS CASEY, San Francisco, CA (US); Gaurav Desai, San Jose, CA (US); Page Furey Crahan, San Francisco, CA (US); Peter Evans, Los Altos Hills, CA (US); Raymond Daly, Palo Alto, CA (US); Xinyue Li, San Mateo, CA (US); Amanda McNary, Redwood City, CA (US); Phillip Ellsworth Stahlfeld, Mountain View, CA (US); David Charles Chou, San Jose, CA (US); Nicole Limtiaco, San Francisco, CA (US)

(21) Appl. No.: 17/644,393

(22) Filed: Dec. 15, 2021

Related U.S. Application Data
(60) Provisional application No. 63/163,252, filed on Mar. 19, 2021.

(51) Int. Cl. G06F 30/20

(52) U.S. Cl. CPC G06F 30/20; G06F 2113/04

(57) ABSTRACT

A computer-implemented method executed by one or more processors includes receiving a request for an output of an electrical grid simulation, the request including data indicating one or more input parameters for the simulation; in response to receiving the request, accessing a virtual model of an electrical grid, the virtual model including multiple different model configurations; selecting, based on the requested output from the simulation, and based on the one or more input parameters for the simulation, (i) a simulation mode including a resolution and scale of the simulation and (ii) one of the multiple different model configurations; executing an electrical grid simulation in the selected simulation mode using the selected model configuration; and based on results of the electrical grid simulation, providing the requested output of the electrical grid simulation.

### CROSS-REFERENCE TO RELATED APPLICATION

This application claims the benefit of U.S. Provisional Application No. 63/163,252, filed Mar. 19, 2021, the contents of which are incorporated by reference herein.

### TECHNICAL FIELD

The present specification relates to electrical power grids, and specifically to performing operational modeling and simulation of an electrical grid system.

### BACKGROUND

Electrical power grids transmit electrical power to loads such as residential and commercial buildings. Electrical power grids transmit electrical power to loads such as residential and commercial buildings. Electrical power grids are complex and require a vast array of commercial, regulatory, legislative, and other stakeholders to evaluate and make investment and operating decisions. To aid in making decisions regarding electrical grid modifications, virtual models of an electrical grid can be used to simulate operations under various conditions.

Historically, decision makers have used different tools or methods to evaluate their electric grid investment decisions. This could range from hiring a consulting firm to perform the evaluation, to establishing an in-house team of experts, and to leveraging any available technology. Given the complexity of modeling and evaluation, and the established decision making criteria of capital expenditure, rate of return, risk and reliability many utilities use three to four software programs, with awkward or non-existent interfaces between them. In many cases, virtual electric grid models are bespoke and re-implemented across utilities, leading to fragmentation between utilities.

Current processes model or evaluate using siloed tools, and the core modeling technology in these siloed tools is limited. Simplifications are made with factors like electrical variables; intra-day, or intra-hour, forecasting of load or generation of price; and even the number of nodes considered in a model. Moreover, these tools use different underlying grid models that magnify the divergence in the results they produce.

### SUMMARY

Techniques are described for simulation of electrical power grid operations. In general, the present disclosure relates to a system for accurately simulating operations of electrical power grids. Electrical grid models are used to evaluate and predict operations and potential faults in an electrical grid. However, present approaches for simulating operations of electric power grids are not adaptable to different time scales and spatial granularity. The present disclosure provides a system and method to perform electrical grid simulations using a virtual electrical grid model that includes multiple layers and versions that can be combined in various configurations. The disclosed techniques use fully-integrated, spatially and temporally fine-grained models of the electric power system, along with an adaptable and scalable simulation engine. The virtual electrical grid model can include representations of existing real-world electrical grid components, representations of planned electrical grid components, or a combination of representations of existing and planned electrical grid components.

In some cases, a grid modeling and simulation system may perform a simulation in response to a request for simulation results that is provided through a user interface. The request may be for output that shows the operational impacts of a change to the electrical grid, such as adding or removing an electrical power source or load. In some cases, the request may be for output that shows the operational impact of an event, such as a lightning strike or an outage of a power generating station connected to the electrical grid.

The grid modeling and simulation system can be adaptable in time resolution and time duration. For example, the system allows simulations across all time scales of interest from nanoseconds to years and at various time resolutions. The grid modeling and simulation system can be adaptable in spatial expanse to enable simulations that can be used to evaluate both hyperlocal and system-wide impacts. For example, the system allows simulations across all spatial scales of interest from meters to hundreds of kilometers at various spatial resolutions.

In some implementations, when the system receives a request for simulation results, the system can select a simulation mode based on the type of request. The simulation mode can include a time resolution, a time scale, a spatial resolution, and a spatial scale of the simulation.

In some implementations, when the system receives a request for simulation results, the system can select a model configuration based on the type of request. The model configuration can include combinations of various layers and versions of the electrical grid model. For example, the virtual electrical grid model can include a physical layer, an economic layer, and an environmental layer. The virtual electrical grid model can also include historical versions, an as-designed version, an as-built version, a current operational version, and future versions. The layers can include layers that are each based on data from different sources, e.g., data from utilities, government organizations, electrical grid sensors, etc.

In an example scenario, the system may receive a request for simulation results showing real-world electrical impacts of a rapid transient event on loads of an electrical feeder. Based on the request, the system can select a simulation mode that includes a time resolution, e.g., of nanoseconds, a time scale, e.g. of seconds, a spatial resolution, e.g., of tenths of a mile, and a spatial scale, e.g., of miles. Based on the request, the system may also select a model configuration including a physical layer of a current operational version of the virtual model that is based on data from the most accurate combination of available data sources.

The system can perform the electrical grid simulation in the selected simulation mode using the selected configuration of the electrical grid model. The system provides the output of the results of the electrical grid simulation, e.g., to a user interface of a computing device.

An electrical grid operations simulation system can be used, for example, by grid operators, e.g., utilities. The simulation system can also be used by project developers, property owners, construction companies, and any other involved parties having interest in making additions and/or changes to an electrical power grid.

An electrical grid can undergo additions and changes on a continual basis. New buildings, renewable power plants, stationary storage, mobile storage, and expansions to existing buildings, facilities, and loads are some examples of potential changes that can be proposed and made to existing electrical distribution feeders. As the electrical power grid becomes more complex and operating values approach critical limits, detailed prediction studies become more important and more complex. Detailed interconnection studies can be performed to document the operating characteristics of the existing power system, and also the predicted operation of the modified system. In this way, the impacts of the proposed interconnection can be fully evaluated before installation.

The simulation system can use a calibrated high resolution power grid model. The power grid model can include a model of the as-built grid, and can also include interconnections that have been approved but not yet built. The simulation system can use the power grid model to compare grid conditions prior to connection of the proposed interconnection to predicted grid conditions after connection of the proposed interconnection, in order to identify incremental effects of the interconnection.

In general, innovative aspects of the subject matter described in this specification can be embodied in a method including actions of receiving a request for an output of an electrical grid simulation, the request including data indicating one or more input parameters for the electrical grid simulation; in response to receiving the request, accessing a virtual model of an electrical grid, the virtual model including multiple different model configurations; selecting, based on the requested output, and based on the one or more input parameters for the simulation, (i) a simulation mode including a resolution and scale of the simulation and (ii) one of the multiple different model configurations; executing the electrical grid simulation in the selected simulation mode using the selected model configuration; and based on results of the electrical grid simulation, providing the requested output of the electrical grid simulation.

These and other implementations can include the following features, alone or in combination. In some implementations, the resolution of the simulation includes a time resolution of the simulation.

In some implementations, the resolution of the simulation includes a spatial resolution of the simulation.

In some implementations, the scale of the simulation includes a time scale of the simulation.

In some implementations, the scale of the simulation includes a spatial scale of the simulation.

In some implementations, the one or more input parameters include at least one of a location, a proposed change to the electrical grid, or a scenario.

In some implementations, the multiple different model configurations include time-varying versions of the virtual model of the electrical grid.

In some implementations, the time-varying versions of the virtual model of the electrical grid including historical versions, current versions, and future versions of the virtual model of the electrical grid.

In some implementations, the current versions of the virtual model of the electrical grid include an as-designed version, an as-built version, and an operational version of the virtual model of the electrical grid.

In some implementations, the future versions of the virtual model of the electrical grid each include: a model of current real-world power grid assets; and a model of one or more planned changes to the electrical grid.

In some implementations, providing the requested output of the electrical grid simulation includes generating a visualization of the requested output for display through a user interface of a computing device.

In some implementations, the virtual model of the electrical grid includes a virtual model of real-world electrical grid assets.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

The subject matter described in this specification can be implemented in various embodiments and may result in one or more of the following technical advantages. The simulation system can perform rapid speed simulation over a variety of dynamic power grid operating conditions over a simulated period of time, e.g., based on historical power grid data. The simulation can include predicted operating conditions over discrete time intervals, e.g., over each hour of a simulated year.

Additional technical advantages of the simulation system include an ability to simulate operations of the electrical grid under various predicted load conditions, including variations due to factors such as seasonal effects, calendar effects, and time of day effects. The simulation system can simulate operations at multiple locations of the electrical grid. The simulation system can simulate various electrical operating characteristics, e.g., current, voltage, power factor, load, etc. at multiple locations, over prolonged simulated periods of time.

The simulation system can model a full transmission and distribution system including electrical properties of grid components, active loads and generators with associated forecasted behavior, and centralized and distributed control. The grid models can enable simulations across any time scale of interest, e.g., from nanoseconds to years, and any geographical area of interest, e.g., from centimeters to thousands of kilometers.

Other implementations of the above aspects include corresponding systems, apparatus, and computer programs, configured to perform the actions of the methods, encoded on computer storage devices. The details of one or more implementations of the subject matter described in this specification are set forth in the accompanying drawings and the description below. Other features, aspects, and advantages of the subject matter will become apparent from the description, the drawings, and the claims.

### DESCRIPTION OF DRAWINGS

FIG. 1 illustrates an example system for simulation of electrical power grid operations.

FIG. 2 illustrates an example process for simulation of electrical power grid operations.

### DETAILED DESCRIPTION

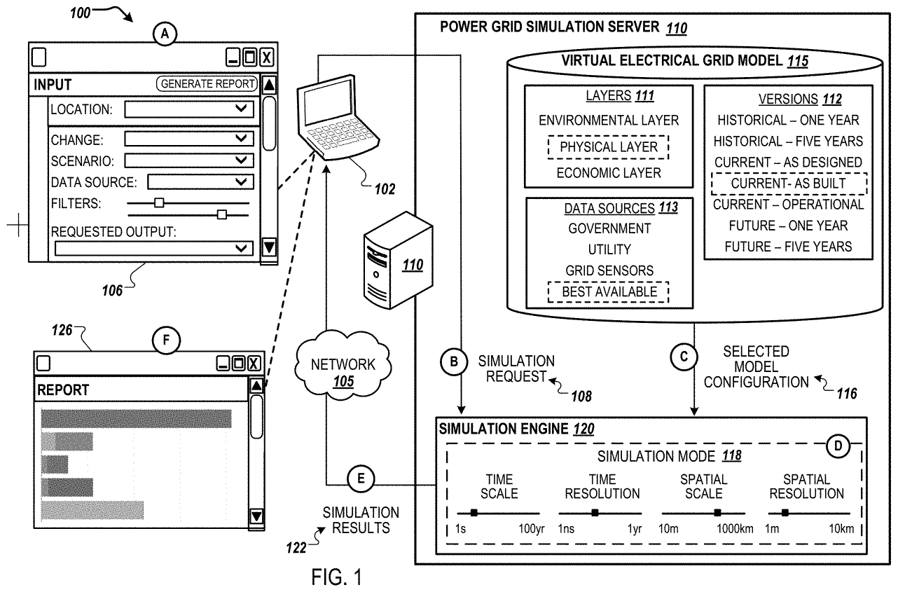

FIG. 1 is a diagram showing an example system 100 for simulation of electrical power grid operations. The system 100 includes a power grid simulation server 110 and a user device 102. The server 110 includes an electrical grid model 115 and a simulation engine 120. The user device 102 may communicate with the server 110 over, for example, a network 105.

In some examples, the electrical grid model 115, the simulation engine 120, or both, can be separate from the server 110 and may communicate with the server 110 over the network 105. The network 105 can include public and/or private networks and can include the Internet.

The user device 102 can be an electronic device such as a computing device. The user device 102 can be, for example, a desktop computer, a laptop computer, a smart phone, a cell phone, a tablet, a PDA, etc.

The server 110 is a server system and can include one or more computing devices. In some implementations, the server 110 may be part of a cloud computing platform. The server 110 may be maintained and operated, for example, by an electrical grid operator such as an electrical power utility or a third party.

In general, a user can provide a simulation request 108 to a simulation server 110 through an input user interface 106 provided through the user device 102. The simulation server 110 can conduct simulations to generate simulation results 122. The simulation server 110 can provide the simulation results 122 to the user device 102. The user device 102 can present the simulation results 122 through an output user interface 126.

FIG. 1 illustrates operations performed by the system 100, shown as stages (A) to (F), with each representing a step in an example process for simulation of electrical power grid operations. Stages (A) to (F) may occur in the illustrated sequence, or in a sequence that is different from the illustrated sequence. For example, some of the stages may occur concurrently.

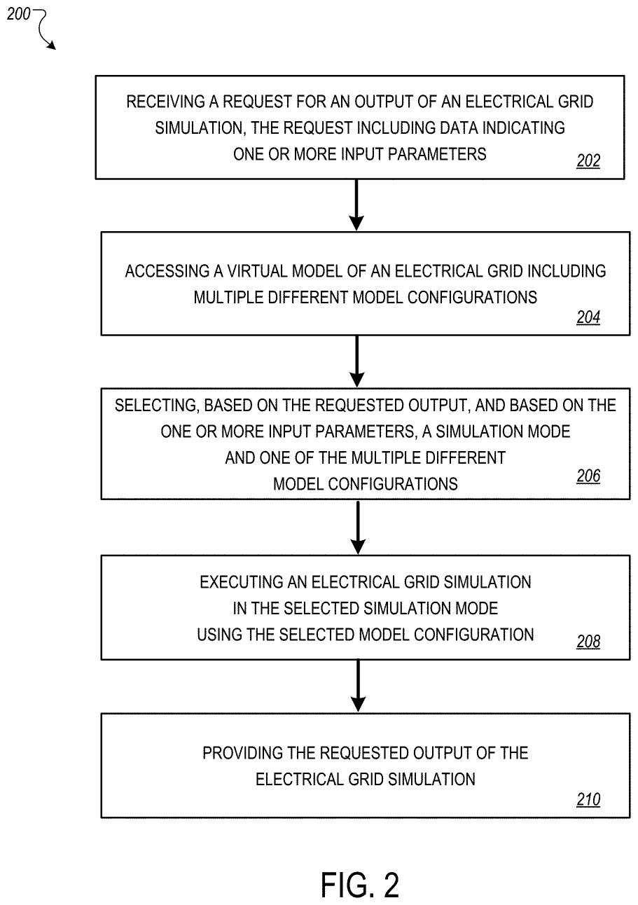

The system 100 can perform simulations of electrical grid operations using a process 200, shown in FIG. 2. The process 200 includes receiving a request for an output of an electrical grid simulation, the request including data indicating one or more input parameters (202).

For example, in stage (A) of FIG. 1, the system 100 displays an input user interface 106 to the user through the user device 102. The input user interface 106 can include an input form to enable a user to input a simulation request 108.

The input user interface 106 includes input fields for various data. For example, the input user interface 106 includes an input field for a location, a change, a scenario, a data source, and requested output. In some examples, the user interface 106 can include more or fewer input fields. The user interface 106 can include input fields in various formats. For example, the user interface 106 can include input fields with drop-down menus, slider icons, text input fields, maps, selectable icons, search fields, etc.

In some examples, the input location can include a center location for the simulation, e.g., a street address or latitude and longitude. The location can also include a radius for the simulation, e.g., in kilometers. In some examples, the location can include a zip code, town, city, or county. In some examples, the location can be input by the user through an interface that displays a map. For example, the user can select regions of a map for the simulation. In some examples, the user can draw boundaries for the simulation on a map.

In an example scenario, the system may receive a request for simulation results showing real-world electrical impacts of a rapid transient event on loads of an electrical feeder if a new solar panel system is connected to the grid. In this example, the input location can be a geographic radius centered at the location of the location of the added solar panel system. The input change can be the addition of the solar panel system. The input scenario can be the rapid transient event. The data source can be the best available aggregated data. The requested output can be a number of faults caused by the rapid transient event.

In another example scenario, the system may receive a request for simulation results showing recommended actions to address a 2 MW power deficiency on an electrical grid feeder. In this example, the input location can be the location of the electrical grid feeder. The input change can be an increase in power output of 2 MW. The input scenario can be normal operation over the course of a year. The data source can be data provided by the electrical utility. The requested output can be a cost and reliability estimate for the recommended actions.

The input user interface can also include filters. For example, the user can apply filters to filter the simulation results. In the above example scenario, the user interface 106 can include filters for reliability and cost. The user can manipulate the icons of the user interface 106 to set a reliability filter to only show recommended actions with greater than ninety percent reliability. The user can also manipulate the input user interface 106 to set a cost filter to only show recommended actions with a cost less than $2.5M.

In stage (B) of FIG. 1, the user device 102 sends the simulation request 108 to the power grid simulation server 110, e.g., over the network 105. The simulation request 108 includes the parameters input by the user, e.g., the location, scenario, change, data source, filters, and requested output. The simulation engine 120 receives the simulation request 108.

The process 200 includes accessing a virtual model of an electrical grid including multiple different model configurations (204). For example, in response to receiving the simulation request 108, the simulation engine 120 accesses the virtual electrical grid model 115. In some examples, the electrical grid model 115 is stored in a database that is stored by or is accessible to the server 110. The electrical grid model 115 can be a model of a real-world electrical power grid that transmits electrical power to loads such as residential and commercial buildings.

In some examples, the electrical grid model 115 can include a high resolution electrical model of one or more electrical distribution feeders. The electrical grid model 115 can include, for example, data models of substation transformers, distribution switches and reclosers, voltage regulation schemes, e.g., tapped magnetics or switched capacitors, network transformers, load transformers, inverters, generators, and various loads. The electrical grid model 115 can include line models, e.g., electrical models of medium voltage distribution lines. The electrical grid model 115 can also include electrical models of fixed and switched line capacitors, as well as other grid components and equipment.

The electrical grid model 115 can include a topological representation of a power grid or a portion of the power grid. The detail of the electrical grid model 115 is sufficient to allow for accurate simulation and representation of steady-state, dynamic and transient operation of the grid. The electrical grid model 115 can include various layers 111 and versions 112. The electrical grid model 115 can also include data from multiple data sources 113. In some examples, the data sources 113 can include a “best available” data source, including aggregated data from multiple data sources.

The layers 111 can include, for example, an environmental layer, a physical layer, and an economic layer. The environmental layer can include data related to the environmental impact of the electrical power grid. For example, the environmental layer can include data related to emissions of power sources powering the electrical power grid. The physical layer can include data related to physical components and operations of the electrical power grid. For example, the physical layer can include data related to equipment performance and specifications. The economic layer can include data related to the cost of the electrical power grid. For example, the economic layer can include data related to the cost of operations and maintenance of the electrical power grid.

The electrical grid model 115 includes different versions of the same electrical grid. Each version may represent the past, the present and the future states of the grid, including changes of topology over time such as introduction of new assets and changing of switch positions. This enables analyzing past behavior as well as series of planned or hypothetical scenarios. Different versions of the electrical grid model 115 can represent the intended grid design, the as-built design, the operational design, and future versions that represent combinations of planned and hypothetical equipment modifications, additions, removals, and replacements.

The versions 112 can include time-varying versions of the electrical grid model. For example, the versions 112 can include historical, current, and future versions of the electrical grid model. The historical versions can include versions of the model that represent the electrical power grid in the past, e.g., one year in the past, five years in the past, or ten years in the past. In some examples, the historical versions can be used to evaluate past performance of the electrical power grid. In some examples, the historical versions can be used for trend analysis and comparison. For example, a same simulation can be run using a historical version and a current version in order to identify any trends in electrical power grid performance over time.

The current versions of the electrical grid model 115 can include an as-designed model of the electrical power grid. The as-designed model of the electrical power grid can include models of power grid assets including their as-designed specifications and ratings. The current versions of the electrical grid model 115 can also include an as-built electrical grid model. The as-built model of the electrical power grid can include models of power grid assets including their real-world ratings. The as-built model can consider real-world effects of aging, degradation, maintenance, etc. The current versions of the electrical grid model 115 can also include a current operational version. The current operational version can include real-time or near real-time data of current operations of the electrical power grid. The current operational version can account for changes in configurations such as changes in switch positions. The current operational version can also account for current failures and outages.

The future versions of the electrical grid model 115 can include versions of the model that represent planned future configurations of the electrical power grid, e.g., one year in the future, five years in the future, or ten years in the future. The future versions of the electrical grid model 115 can include models of planned changes to the power grid, e.g., planned grid modifications that have not yet been built. In this way, cumulative impacts of multiple planned modifications can be modeled.

In some examples, the future versions of the electrical grid model 115 can include models of changes that have previously been simulated. For example, a user can input a request for simulation based on a version of the electrical grid model 115 that includes a first proposed change. The simulation server 110 can then save the version of the electrical grid model 115 that includes the first proposed change. A user can then input a request for simulation based on a version of the electrical grid model that includes a second proposed change in addition to the first proposed change. In this way, cumulative impacts of multiple proposed modifications can be modeled. In some examples, a first proposed change may be requested by a first user, and a second proposed change may be requested by a second user. The simulation server 110 can perform simulations incorporating the proposed changes requested by both the first user and by the second user. In this way, the simulation server 110 can enable collaboration between users by simulating cumulative impacts of multiple proposed changes that may be input by multiple different users.

The future versions of the electrical grid model 115 can account for expected component aging, degradation, failures, and upgrades. For example, based on the average life cycle of a component, the future versions of the electrical grid model 115 can model the degradation of the component until its end-of-life, and then account for planned performance of a replacement component. The future versions of the electrical power grid can also account for planned additions, for example, a power source that is expected to come online at a particular date in the future.

In some examples, the future versions of the electrical grid model 115 can vary according to dates along a timeline. For example, a user may be able to specify a future date, e.g., of May 6, 2028, for running a simulation. The simulation can then be performed on a future version of the electrical power grid that corresponds to the date of May 6, 2028, including any expected modifications, additions, deletions, replacements, and degradation as of that date.

In some examples, the future versions of the electrical grid model 115 can account for expected environmental and societal changes. For example, future versions of the electrical grid model 115 can account for changes in climate at the geographic location of the electrical grid. The future versions of the electrical grid model 115 can also account for changes in population, e.g., based on community growth models of the geographic location of the electrical grid. Predicted changes in climate and climate and population can be used to predict the future power demand from the electrical grid.

The electrical grid model 115 can adapt to differing levels of confidence, using machine learning to fill in gaps where model information is unknown or known with low confidence. For example, if provided connectivity data is insufficient, the model may augment automatically with connectivity information deduced from computer vision processing. For example, the electrical grid model 115 can include probabilistic models for the electrical properties of grid devices, power consumption, power generation, and asset failure based on estimated asset health.

The electrical grid model 115 can derive probabilistic information from historical and current versions of the electrical power grid. For example, to predict effects of a future modification of the electrical power grid, the electrical grid model 115 can analyze effects of previous similar modifications to the electrical power grid. The electrical grid model 115 can also incorporate and analyze historical data from electrical grids in various geographic locations. In this way, the electrical grid model 115 can use machine learning to identify trends and patterns in order to predict equipment performance in the future.

The data sources 113 can include, for example, government sources, utility sources, and grid sensors. The government sources can include data that is available from a government entity, e.g., a national energy regulatory commission or a state utility commission. The utility sources can include utility companies, e.g., Pacific Gas and Electric or Xcel Energy. The data sources 113 can also include grid sensors. For example, the grid sensors can be located at various locations of the power grid and can transmit operational data to the power grid simulation server 110. The grid sensor data can include historical grid sensor data, near real-time grid sensor data, or both.

In some examples, the data sources 113 can be aggregated to a “best available” data source. For example, data from the various data sources can be associated with a confidence value. The best available data source can include data from government sources, utility sources, and grid sensors. When a data point conflicts between two or more data sources, the best available data can be selected based on the data source having the highest confidence for the data point.

In some examples, a data source 113 for a simulation can be selected by a user, e.g., through the user interface 106. In some examples, the simulation engine 120 can select one or more data sources 113 based on the data provided through the simulation request 108.

The electrical grid model 115 can be adaptive such that a change in one aspect of the electrical grid model 115 persists to all other aspects. For example, a new inverted-connected resource may be connected to the electrical power grid. The electrical grid model 115 can receive data indicating the new resource, e.g., from one or more of the data sources 113. The electrical grid model 115 can incorporate the new resource into each of the environmental, physical, and economic layers 111. The electrical grid model 115 can also incorporate the new resource into the current and future versions of the model.

The electrical grid model 115 can take into account the interdependency of energy systems beyond the electrical grid, such as the electrical elements of a natural gas storage, distribution and electrical generation system. The electrical grid model 115 can model interactions between the two systems. Backup power systems interacting with primary power systems is another example, particularly for battery and solar powered systems that may replace diesel generator systems. Detailed models of all interacting subsystems with associated simulations of all normal, abnormal and corner conditions can be performed.

The electrical grid model 115 can be calibrated by using measured electrical power grid data. The measured electrical power grid data can include historical grid operating data. The historical grid operating data can be collected during grid operation over a period of time, e.g., a number of weeks, months, or years. In some examples, the historical grid operating data can be average historical operating data. For example, historical grid operating data can include an electrical load on a substation during a particular hour of the year, averaged over multiple years. In another example, historical grid operating data can include a number of voltage violations of the electrical power grid during a particular hour of the year, possibly averaged over multiple years, or otherwise represented statistically.

In some examples, the electrical grid model 115 can include assumptions. For example, the electrical grid model 115 can include measured data for certain locations of the power grid, and might not include measured data for other locations. The electrical grid model 115 can use assumptions to interpolate grid operating data for locations in which measurements are not available. An assumption can be, for example, an assumed ratio or relationship between loads at industrial locations of the power grid compared to residential locations of the power grid.

In some examples, the electrical grid model 115 can include measured data for certain time intervals, e.g., certain hours, and might not include measured data for other time intervals. The electrical grid model 115 can use assumptions to estimate or interpolate grid operating data for time intervals in which measurements are not available. An assumption can be, for example, an assumed relationship between loads at a particular location at nighttime compared to daytime. In another example, an assumption can be an assumed relationship between loads at a particular location during an hour of the day in summertime, compared to during the same hour of the day in wintertime.

In some examples, the electrical grid model 115 can include measured data for certain characteristics, e.g., electrical load, and might not include measured data for other characteristics. The electrical grid model 115 can use assumptions to estimate grid operating data for characteristics for which measurements are not available. An assumption can be, for example, an assumed relationship between load and voltage at a particular location of the power grid.

In some examples, measured data can be used to resolve and reduce errors caused by assumptions in the electrical grid model 115. In some examples, the electrical grid model 115 can include conservative values in place of missing or incomplete data. In some examples, the electrical grid model 115 can use worst case assumptions to enable worst case analysis.

The process 200 includes selecting, based on the requested output from the simulation, and based on the one or more input parameters, a simulation mode and one of the multiple different model configurations (206). For example, in stage (C) of FIG. 1, the simulation engine 120 selects a model configuration 116 of the virtual electrical grid model 115. The selected model configuration 116 can include, for example, one or more layers 111, versions 112, and data sources 113. The simulation engine 120 selects the model configuration 116 based on the simulation request 108. For example, a simulation request 108 may include a request for physical effects of a transient on the electrical grid in present day, modeled to the best available accuracy. Based on the request, the system may select a model configuration including a physical layer of a current as-built version of the virtual model that is based on data from the best available combination of data sources.

In some implementations, the simulation engine 120 includes a ruleset defining various combinations of user inputs for a simulation request 108 and appropriate simulation model configurations 116 for each combination of user inputs. The simulation engine 120 can select the model configuration 116 for a given simulation request 108 by matching the inputs of the simulation request 108 with one of the input combinations defined in the ruleset. The simulation engine 120 would select the model configuration 116 associated with the particular rule of the ruleset that defines a similar combination of user inputs as those provided with the given simulation request 108.

In stage (D) of FIG. 1, the simulation engine 120 selects a simulation mode 118 for the simulation. The simulation mode 118 can include a time scale, time resolution, spatial scale, and spatial resolution of the simulation.

The simulation mode 118 can include various time scales. The time scale indicates a simulated time duration of a simulation. For example, a simulation can generate data indicating predicted electrical grid operations over a time scale of ten years. Generally, a higher time scale corresponds to a larger time duration. For example, a time scale of ten years is a larger time scale than a time scale of one year.

In some examples, a time scale can include a number of milliseconds, seconds, hours, days, years, etc. In some examples, a simulation can include a transient simulation with a shorter time scale when issues are expected to arise in that time domain, while leaving simulation in the steady-state time domain with a larger time scale when transient effects are not expected.

The simulation mode 118 can include various time resolutions. The time resolution indicates a level of detail of a simulation in a time dimension. In some examples, the time resolution can be the time increments of data points of a simulation. Generally, a higher time resolution corresponds to a smaller unit of time measurement. For example, a time resolution of one second is a higher resolution than a time resolution of one minute.

In some examples, a time resolution can include nanoseconds, milliseconds, seconds, minutes, hours, days, weeks, months, etc. For example, the simulation engine 120 can select a time resolution of milliseconds to model transient events. The simulation engine 120 can select a time resolution of days to model steady-state events. In some examples, the simulation engine 120 can perform a simulation at a first time resolution for a portion of a simulation, and at a second time resolution for another portion of the simulation.

In some examples, the simulation engine 120 can select a time scale and time resolution based at least in part on an amount of data that will be generated. For example, a first simulation run over large time scale, e.g., of ten years, with a high time resolution, e.g., of seconds, would generate a larger amount of data compared to a second simulation run over a time scale of ten years with a smaller time resolution, e.g., of weeks. Therefore, the first simulation would likely require more processing time, processing power, and data storage compared to the second simulation. Thus, the simulation engine 120 can select an appropriate time scale and time resolution in order to obtain results without exceeding limits or thresholds related to the amount of generated data.

The simulation mode 118 can include various spatial scales. The spatial scale indicates a simulated spatial size or expanse of a simulation. In some examples, the spatial scale can be a size as measured in distance, e.g., kilometers. In some examples, the spatial scale can be a size as measured in area, e.g., square kilometers. For example, a simulation can generate data indicating predicted electrical grid operations over a spatial scale of ten square kilometers. Generally, a higher spatial scale corresponds to a larger spatial distance or area. For example, a spatial scale of ten square kilometers is a larger spatial scale than a time scale of square kilometer.

In some examples, a spatial scale can include meters, kilometers, tens of kilometers, hundreds of kilometers, thousands of kilometers, etc. For example, the simulation engine 120 can simulate large systems, on the scale of full interconnections, by taking advantage of distributed computing. The spatial scale can correspond to a geographic area of an electrical feeder, or of multiple connected electrical feeders. In some examples, the simulation engine 120 can simulate transient events with a simulation mode that includes a spatial scale on a local level. For example, the spatial scale can correspond to the size of a neighborhood, town, city, etc. In some examples, the simulation engine 120 can simulate large modifications with a simulation mode that includes a spatial scale at a regional level. For example, the spatial scale can correspond to the size of a county, state, province, etc.

The simulation mode 118 can include various spatial resolutions. The spatial resolution indicates a level of detail of a simulation in physical dimensions. In some examples, the spatial resolution can be the linear spacing of data points of a simulation. In some examples, the spatial resolution can be a size of an area represented by a single reference point. Generally, a higher spatial resolution corresponds to a smaller unit of spatial measurement. For example, a spatial resolution of one meter is a higher resolution than a spatial resolution of one kilometer.

In some examples, a spatial resolution can include centimeters, meters, tens of meters, kilometers, etc. The simulation engine 120 can perform simulations that span a range of granularity in terms of model detail. The electrical grid model 115 includes models of generation resources at various levels, including bulk power and distributed resources, conventional power plants and intermittent renewables, as well as energy storage systems. The simulation mode 118 can include a spatial resolution corresponding to subcomponent-granularity when analyzing hyperlocal impacts. The simulation mode 118 can include a spatial resolution corresponding to higher-level model granularity when analyzing broader system-level impacts. In some examples, the simulation mode 118 can include a higher spatial resolution at certain locations of the grid, and a lower spatial resolution at other locations of the grid. For example, the simulation engine 120 can select a higher spatial resolution, e.g., of centimeters, for modeling a portion of the grid, e.g., a portion of the grid that occupies a square tenth of a kilometer. The simulation engine can select a lower spatial resolution, e.g., of tens of meters, for modeling another portion of the grid, e.g., a portion of the grid that occupies ten square kilometers.

In some examples, the simulation engine 120 can select a spatial scale and spatial resolution based at least in part on an amount of data that will be generated. For example, a first simulation run over large spatial scale, e.g., of one hundred kilometers, with a high spatial resolution, e.g., of centimeters, would generate a larger amount of data compared to a second simulation run over a spatial scale of one hundred kilometers with a smaller spatial resolution, e.g., of ten meters. Therefore, the first simulation would likely require more processing time, processing power, and data storage compared to the second simulation. Thus, the simulation engine 120 can select an appropriate spatial scale and spatial resolution in order to obtain results without exceeding limits or thresholds related to the amount of generated data.

The simulation engine 120 is adaptive and can take full advantage of the details provided by the electrical grid model 115. The simulation engine 120 can be capable of switching between different simulation modes 118 based on the scales and resolutions that are appropriate for the events being simulated. For example, the simulation engine 120 can simulate steady state power flow before and after a capacitor switching event, and model the capacitor switching event itself in the time domain to analyze the electromagnetic transients.

The simulation engine 120 can switch between models of subnetworks with different levels of detail depending on the subnetwork's electrical distance to the events being simulated. For example, the simulation engine 120 can simulate a distribution feeder connected to the transmission system as a single load, but then switch to a full feeder model when simulating a fault near its substation.

The simulation engine 120 can simulate the behavior of active, controllable devices on the grid including bulk power generation, transmission and distribution system controls, and distributed energy resources such as photovoltaic and battery systems.

The simulation engine 120 can simulate a distribution of voltage and current values by treating the simulation as a stochastic process. Each simulation step can sample from provided distributions of electrical properties, load, and generation. Running many of these simulations enables estimating a distribution over the outcomes and defining confidence intervals around the predicted behavior.

The simulation engine 120 can perform simulations based on the concept of Electro-Magnetic Transients but applied to every detail and every aspect of the combined electrical, mechanical, thermal, hydrocarbon-fuel subsystem. In an example, the simulation engine 120 can simulate a low-inertia, highly intermittent grid with a high proportion of electronic interfaces such as inverters between both sources and loads.

The process 200 includes executing an electrical grid simulation in the selected simulation mode using the selected model configuration (208). The simulated power grid data can be based on simulating operation of the power grid during a simulated time period. The simulated power grid data can include a number of different temporal and spatially dependent characteristics of the power grid.

The simulated time period can be, for example, a simulated year. In some examples, the simulation engine 120 can generate simulated power grid data, or simulation results, for each hour of the simulated year. The simulation can include predicted loads and transients over the course of the simulated year based on historical data. For example, predicted loads may vary based on predicted seasonal effects (e.g., weather conditions) and calendar effects (e.g., weekends, holidays).

The location in the power grid can include a geographic location identified by the simulation request. For example, the location can include a postal address or a latitude and longitude coordinate position.

The simulation engine 120 can then perform a series of simulations. The simulations can be based on, for example, root-mean-square (RMS), power flow, positive sequence, and/or time series voltage transient analysis. The amount of data processed during each simulation can depend on the size and framework of the distribution feeder that is being evaluated. The simulation can analyze predicted effects for all connections to the affected distribution feeder and all components of the affected distribution feeder. Thus, the complexity of simulations can vary depending on construction of the distribution feeder.

For example, the simulations can vary depending on length, power, and number of loads of a distribution feeder. A typical distribution feeder can range in length from approximately one mile to ten miles. A typical distribution feeder can range in power from approximately one to ten megawatts. The number of loads connected to a feeder can range from a few hundred residential loads to several thousand residential loads. In some cases, there may also be as few as a few dozen commercial or industrial loads, and as many as hundreds of commercial or industrial loads.

The construction of a distribution feeder can also vary based on location. In urban environments, residential loads typically share transformers. In rural environments, each residential load may have a separate transformer. Commercial and industrial loads are typically served by three-phase transformers. Thus, the number of loads and transformers in a feeder could be as low as a few hundred loads with a few hundred transformers for a rural feeder. The number of loads and transformers in a feeder could be as many as thousands of loads with hundreds of single phase transformers in an urban environment, coupled with dozens or hundreds of larger three phase loads and transformers.

In some examples, the simulation engine 120 can simulate operation of multiple feeders. For example, simulations can include analyses of operation of all feeders across a geographic region, e.g., a city, county, province, or state. In some cases, the simulation engine 120 can model operation of each individual feeder within the region, and can aggregate the results in order to model operation of the multiple feeders of the region.

In some cases, the simulation engine 120 can model operational impacts of multiple feeders on each other. For example, multiple feeders may connect to a shared substation transformer. The simulation engine 120 can simulate the impacts of transients of one feeder on another feeder that is connected to the same transformer.

The simulation engine 120 can analyze the expected operation of the power grid by applying empirical historical data to the grid model. The empirical historical data can include historical electrical grid characteristics based on, for example, measurements, calculations, estimates, and interpolations. The characteristics can include, for example, load, voltage, current, and power factor. The empirical historical data can represent power grid operation of multiple interconnected components within a designated geographical area. The empirical historical data can represent average electrical grid operating characteristics over a period of time, e.g., multiple weeks, months, or years.

In some examples, the simulations can cover a range of operating conditions, particularly under extremes of voltage from the Bulk Power System (BPS) and extremes in load on the electrical distribution feeder. The simulation engine 120 can simulate corner cases of the system with the proposed interconnection added to the existing system. The simulations can also cover electrical grid conditions during steady-state operation and during transient operation. The simulation engine 120 can accurately simulate operations of loads and sources, aggregated loads and sources, and disaggregated loads and sources.

Based on the series of simulations, the simulation engine 120 outputs simulation results 122. The simulation results can include time-varying electrical power grid characteristics at different locations of the electrical power grid for the simulated time period.

The process 200 includes providing the requested output of the electrical grid simulation (210). For example, in stage (E) of FIG. 1, the simulation server 110 outputs the simulation results 122 to the user device 102. The user device 102 can display the simulation results 122 for viewing by a user, e.g., through an output user interface 126.

In stage (F) of FIG. 1, the user device 102 displays the simulation results 122 to a user through the output user interface 126. The output user interface 126 can display, for example, graphs, charts, and tables that indicate results of the simulation. In some examples, the output user interface 126 can display a visualization of the simulation results 122 in a two-dimensional and/or three-dimensional map view. The output user interface 126 can also display data including expected effects of proposed changes to the electrical grid. Expected effects can include costs, environmental effects such as changes in emissions, and changes in reliability of the electrical grid. The output user interface 126 can be interactive in order to enable a user to examine the results. For example, a user can select, e.g., using a computer mouse, an individual test, time period, or location, in order to view respective detailed simulation results.

This disclosure generally describes computer-implemented methods, software, and systems for electrical power grid visualization. A computing system can receive various electrical power grid data from multiple sources. Power grid data can include different temporal and spatially dependent characteristics of a power grid. The characteristics can include, for example, power flow, voltage, power factor, feeder utilization, and transformer utilization. These characteristics can be coupled; for example, some characteristics may influence others and/or their temporal and spatial dependence may be related.

Data sources can include satellites, aerial image databases, publicly available government power grid databases, and utility provider databases. The sources can also include sensors installed within the electrical grid by the grid operator or by others, e.g., power meters, current meters, voltage meters, or other devices with sensing capabilities that are connected to the power grid. Data sources can include databases and sensors for both high voltage transmission and medium voltage distribution and low voltage utilization systems.

The data can include, but is not limited to, map data, transformer locations and capacities, feeder locations and capacities, load locations, or a combination thereof. The data can also include measured data from various points of the electrical grid, e.g., voltage, power, current, power factor, phase, and phase balance between lines. In some examples, the data can include historical measured power grid data. In some examples, the data can include real-time measured power grid data. In some examples, the data can include simulated data. In some examples, the data can include a combination of measured and simulated data.

Implementations of the subject matter and the functional operations described in this specification can be implemented in digital electronic circuitry, in tangibly-implemented computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including, by way of example, a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example Linux, UNIX, Windows, Mac OS, Android, iOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a central processing unit (CPU), a FPGA (field programmable gate array), or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN), a wide area network (WAN), e.g., the Internet, and a wireless local area network (WLAN).

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any system or on the scope of what may be claimed, but rather as descriptions of features that may be specific to particular implementations of particular systems. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of sub-combinations.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be helpful. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art.

For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

1. A computer-implemented method comprising:
receiving a request for an output of an electrical grid simulation, the request including data indicating one or more input parameters for the electrical grid simulation;
in response to receiving the request, accessing a virtual model of an electrical grid, the virtual model including multiple different model configurations;
selecting, based on the requested output, and based on the one or more input parameters for the simulation, (i) a simulation mode including a resolution and scale of the simulation and (ii) one of the multiple different model configurations;
executing the electrical grid simulation in the selected simulation mode using the selected model configuration; and
based on results of the electrical grid simulation, providing the requested output of the electrical grid simulation.

2. The method of claim 1, wherein the resolution of the simulation comprises a time resolution of the simulation.

3. The method of claim 1, wherein the resolution of the simulation comprises a spatial resolution of the simulation.

4. The method of claim 1, wherein the scale of the simulation comprises a time scale of the simulation.

5. The method of claim 1, wherein the scale of the simulation comprises a spatial scale of the simulation.

6. The method of claim 1, wherein the one or more input parameters comprise at least one of a location, a proposed change to the electrical grid, or a scenario.

7. The method of claim 1, wherein the multiple different model configurations include time-varying versions of the virtual model of the electrical grid.

8. The method of claim 7, wherein the time-varying versions of the virtual model of the electrical grid including historical versions, current versions, and future versions of the virtual model of the electrical grid.

9. The method of claim 8, wherein the current versions of the virtual model of the electrical grid include an as-designed version, an as-built version, and an operational version of the virtual model of the electrical grid.

10. The method of claim 8, wherein the future versions of the virtual model of the electrical grid each comprise:
a model of current real-world power grid assets; and
a model of one or more planned changes to the electrical grid.

11. The method of claim 1, wherein providing the requested output of the electrical grid simulation comprises generating a visualization of the requested output for display through a user interface of a computing device.

12. The method of claim 1, wherein the virtual model of the electrical grid comprises a virtual model of real-world electrical grid assets.

13. A system comprising one or more computers and one or more storage devices on which are stored instructions that are operable, when executed by the one or more computers, to cause the one or more computers to perform operations comprising:
receiving a request for an output of an electrical grid simulation, the request including data indicating one or more input parameters for the electrical grid simulation;
in response to receiving the request, accessing a virtual model of an electrical grid, the virtual model including multiple different model configurations;
selecting, based on the requested output, and based on the one or more input parameters for the simulation, (i) a simulation mode including a resolution and scale of the simulation and (ii) one of the multiple different model configurations;
executing the electrical grid simulation in the selected simulation mode using the selected model configuration; and
based on results of the electrical grid simulation, providing the requested output of the electrical grid simulation.

14. The system of claim 13, wherein the resolution of the simulation comprises a time resolution of the simulation.

15. The system of claim 13, wherein the resolution of the simulation comprises a spatial resolution of the simulation.

16. The system of claim 13, wherein the scale of the simulation comprises a time scale of the simulation.

17. The system of claim 13, wherein the scale of the simulation comprises a spatial scale of the simulation.

18. The system of claim 13, wherein the one or more input parameters comprise at least one of a location, a proposed change to the electrical grid, or a scenario.

19. The system of claim 13, wherein the multiple different model configurations include time-varying versions of the virtual model of the electrical grid.

20. A non-transitory computer storage medium encoded with instructions that, when executed by one or more computers, cause the one or more computers to perform operations comprising:
receiving a request for an output of an electrical grid simulation, the request including data indicating one or more input parameters for the electrical grid simulation;
in response to receiving the request, accessing a virtual model of an electrical grid, the virtual model including multiple different model configurations;
selecting, based on the requested output, and based on the one or more input parameters for the simulation, (i) a simulation mode including a resolution and scale of the simulation and (ii) one of the multiple different model configurations;
executing the electrical grid simulation in the selected simulation mode using the selected model configuration; and
based on results of the electrical grid simulation, providing the requested output of the electrical grid simulation.
